(19) United States
(12) Patent Application Publication
(10) Pub. No.: US 2026/0291764 A1
(43) Pub. Date: Sep. 24, 2026

(54) DATA TRANSMISSION DEVICE ON SERVER, DATA TRANSMISSION METHOD AND PROGRAM ON SERVER

(71) Applicant: NTT, Inc., Tokyo (JP)

(72) Inventors: Ko NATORI, Musashino-shi, Tokyo (JP); Kei FUJIMOTO, Musashino-shi, Tokyo (JP); Ikuo OTANI, Musashino-shi, Tokyo (JP); Shogo SAITO, Musashino-shi, Tokyo (JP)

(73) Assignee: NTT, Inc., Tokyo (JP)

(21) Appl. No.: 18/716,231

(22) PCT Filed: Dec. 6, 2021
(86) PCT No.: PCT/JP2021/044736

§ 371 Date: May 21, 2026

(51) Int. Cl. H04L 12/12; G06F 9/4401; G06F 9/48

(52) U.S. Cl. CPC H04L 12/12; G06F 9/4418; G06F 9/4825

(57) ABSTRACT

An on-server data transmission device (200) includes: a traffic characteristic information collecting part configured to collect traffic characteristic information regarding a packet transfer; a polling determination part configured to, based on the received traffic characteristic information, generate polling schedule information for waking up a polling thread at a timing at which a packet arrival probability is equal to or greater than a predetermined threshold and causing the polling thread to sleep at other timings; and a polling instruction part configured to, based on received time synchronization information and polling schedule information, deliver a polling schedule indicating a time and time period in which polling is required to the polling thread to cause the polling thread to perform polling only for the time period indicated by the polling schedule.

### CROSS-REFERENCE TO RELATED APPLICATIONS

This is a National Stage Application of PCT Application No. PCT/JP2021/044736, filed on Dec. 6, 2021. The disclosure of the prior application is considered part of the disclosure of this application, and is incorporated in its entirety into this application.

### TECHNICAL FIELD

The present invention relates to an on-server data transmission device, an on-server data transmission method, and an on-server data transmission program.

### BACKGROUND ART

Against the background of advances in virtualization technology achieved through NFV (Network Functions Virtualization), systems are being constructed and operated on a per-service basis. Also, a mode called SFC (Service Function Chaining) is becoming mainstream, in which, based on the above-described mode of constructing a system on a per-service basis, service functions are divided into units of reusable modules and are operated on independent virtual machine (VM: Virtual Machine, container, etc.) environments, and thereby the service functions are used as needed in a manner as if they are components, and the operability is improved.

A hypervisor environment consisting of Linux (registered trademark) and a KVM (kernel-based virtual machine) is known as a technology for forming a virtual machine. In this environment, a Host OS (an OS installed on a physical server is called a “Host OS”) in which a KVM module is incorporated operates as a hypervisor in a memory area called kernel space, which is different from user spaces. In this environment, the virtual machine operates in a user space, and a Guest OS (an OS installed on a virtual machine is called a Guest OS) operates in the virtual machine.

Unlike the physical server in which the Host OS operates, in the virtual machine in which the Guest OS operates, all hardware (HW) including network devices (such as Ethernet (registered trademark) card devices) is controlled via registers, which is needed for interrupt processing from the HW to the Guest OS and for writing from the Guest OS to the hardware. In such register-based control, the performance is generally lower than that in the Host OS environment because the notifications and processing that would have been executed by physical hardware are emulated virtually by software.

To deal with this degraded performance, there is a technique of reducing HW emulation from a Guest OS, in particular, for a Host OS and an external process present outside of the virtual machine of the Guest OS, to improve performance and versatility of communication using a high-speed and consistent interface. As such a technique, a device abstraction technique called virtio, that is, a para-virtualization technique, has been developed and already been applied to many general-purpose OSes, such as FreeBSD (registered trademark) as well as Linux (registered trademark) and currently put into practical use (see Patent Literatures 1 and 2).

In virtio, regarding data input/output such as console input/output, file input/output, and network communication, as a unidirectional data transfer transport, data exchange using a queue designed with a ring buffer are defined as queue operations. By using the virtio queue specifications and preparing queues whose number and sizes are suitable for each device when the Guest OS starts up, communication between the Guest OS and the outside of its virtual machine can be realized merely through operations on the queues without performing hardware emulation.

Techniques of data transfer in a server include New API (NAPI), Data Plane Development Kit (DPDK), and Kernel Busy Poll (KBP).

New API (NAPI) performs, when a packet arrives, packet processing in response to a software interrupt request after a hardware interrupt request (see Non-Patent Literature 1) (see FIG. 15 described later).

DPDK implements a packet processing function in the user space in which the application operates and, when a packet arrives, immediately dequeues the packet from the user space according to a polling model (see Non-Patent Literature 2). In detail, DPDK is a framework for controlling a network interface card (NIC), which was conventionally controlled by a Linux kernel (registered trademark), in a user space. The biggest difference from the processing in the Linux kernel is that it has a polling-based reception mechanism called pull mode driver (PMD). Normally, with a Linux kernel, an interrupt occurs upon arrival of data on the NIC, and this interrupt triggers the execution of reception processing. On the other hand, in a PMD, a dedicated thread continuously checks arrival of data and performs reception processing. High-speed packet processing can be performed by eliminating the overhead of context switching, interrupts, and the like. DPDK significantly increases packet processing performance and throughput, making it possible to ensure more time for processing of data plane applications. However, DPDK exclusively uses computer resources such as a CPU (Central Processing Unit) and an NIC.

Non-Patent Literature 3 describes a server network delay control device (KBP: Kernel Busy Poll). KBP constantly monitors packet arrivals according to a polling model in a kernel. With this, softIRQ is refrained, and low-latency packet processing is achieved.

### Rx-Sided Packet Processing by New API (NAPI)

FIG. 15 is a schematic diagram of Rx-side packet processing by New API (NAPI) implemented in Linux kernel 2.5/2.6 and later versions (see Non-Patent Literature 1).

As illustrated in FIG. 15, New API (NAPI) executes, on a server including an OS 70 (e.g., a Host OS), a data processing APL 1 deployed in a user space 60, which can be used by a user, and performs packet transfer between an NIC 11 of HW 10, connected to the OS 70, and data processing APL 1.

OS 70 has a kernel 71, a ring buffer 72, and a driver 73, and kernel 71 has a protocol processor 74.

Kernel 71 has the function of the core part of OS 70 (e.g., Host OS). Kernel 71 monitors hardware and manages execution status of programs, on a per-process basis. Here, kernel 71 responds to requests from data processing APL 1 and conveys requests from HW 10 to data processing APL 1. In response to a request from data processing APL 1, kernel 71 performs processing via a system call (a “user program operating in a non-privileged mode” requests processing to a “kernel operating in a privileged mode”).

Kernel 71 transmits packets to data processing APL 1 via a Socket 75. Kernel 71 receives packets from data processing APL 1 via socket 75.

Ring buffer 72 is managed by kernel 71 and is in the memory space in the server. Ring buffer 72 is a constant-sized buffer that stores messages output by kernel 71 as logs, and is overwritten from the beginning when the messages exceed a maximum size.

Driver 73 is a device driver for monitoring hardware in kernel 71. Incidentally, driver 73 depends on kernel 71, and is replaced if the source code of the created (built) kernel is modified. In this case, a corresponding driver source code is to be obtained and rebuilding is to be performed on the OS that will use the driver, to create the driver.

Protocol processor 74 performs protocol processing of L2 (data link layer)/L3 (network layer)/L4 (transport layer), which are defined by the Open Systems Interconnection (OSI) reference model.

Socket 75 is an interface for kernel 71 to perform inter-process communication. Socket 75 has a socket buffer and does not frequently cause a data copying process. The flow up to the establishment of communication via Socket 75 is as follows. 1. The server side creates a socket file according to which the server side accepts clients. 2. Name the acceptance socket file. 3. Create a socket queue. 4. Accept a first connection from a client that is in the socket queue. 5. The client side creates a socket file. 6. The client side sends a connection request to the server. 7. The server side creates a connection socket file separately from the acceptance socket file. As a result of establishing communication, data processing APL 1 becomes able to call a system call, such as read( ) and write( ), to kernel 71.

In the above configuration, kernel 71 receives a notification of a packet arrival from NIC 11 via a hardware interrupt (hardIRQ) and schedules a software interrupt (softIRQ) for packet processing.

Above-described New API (NAPI), implemented in Linux kernel 2.5/2.6 and later versions, processes, upon arrival of a packet, the packet by a software interrupt (softIRQ) after the hardware interrupt (hardIRQ). For example, as illustrated in FIG. 15, in packet transfer based on the interrupt model, a packet is transferred through interrupt processing (see reference sign a in FIG. 15), and therefore a wait due to the interrupt processing occurs and the delay in packet transfer increases.

An overview of Rx-side packet processing of NAPI will be described below.

### Configuration of Rx-Side Packet Processing by New API (NAPI)

FIG. 16 is an explanatory diagram for explaining an overview of Rx-side packet processing by New API (NAPI) at the part surrounded by the dashed line in FIG. 15.

### <Device Driver>

As illustrated in FIG. 16, components deployed in the device driver include: NIC 11, which is a network interface card (physical NIC); hardIRQ 81, which is a handler called due to the generation of a processing request from NIC 11 to perform the requested processing (hardware interrupt); and netif_rx 82, which is a processing function part for the hardware interrupt.

### <Networking Layer>

The components deployed in the networking layer include: softIRQ 83, which is a handler called due to the generation of a processing request from netif_rx 82 to perform the requested processing (software interrupt); and do_softirq 84, which is a control function part that performs the actual part of the software interrupt (softIRQ). The components deployed in the networking layer further include: net_rx_action 85, which is a packet processing function part that is executed upon reception of the software interrupt (softIRQ); a poll_list 86, in which information on a net device (net_device), indicative of which device the hardware interrupt from NIC 11 comes from, is registered; netif_receive_skb 87, which creates a sk_buff structure (structure for enabling the kernel 71 to know the structure of the packet); and a ring buffer 72.

### <Protocol Layer>

The components deployed in the protocol layer include: ip_rcv 88, arp_rcv 89, and the like, which are packet processing function parts.

The above-described netif_rx 82, do_softirq 84, net_rx_action 85, netif_receive_skb 87, ip_rcv 88, and arp_rcv 89 are program components (function names) used for packet processing in kernel 71.

### Rx-Side Packet Processing Operation by New API (NAPI)

The arrows (reference signs) b to m in FIG. 16 indicate the flow of the Rx-side packet processing.

A hardware function part 11a of NIC 11 (hereinafter referred to as “NIC 11”) is configured to, upon reception of a packet in a frame (or upon reception of a frame) from a counterpart device, copy the arrived packet to ring buffer 72 by a Direct Memory Access (DMA) transfer (see reference sign b in FIG. 16), without using the CPU. Ring buffer 72 is managed by kernel 71 in a memory space in the server (see FIG. 15).

However, kernel 71 cannot notice the arrived packet simply by NIC 11 copying the arrived packet to ring buffer 72. In view of this, when the packet arrives, NIC 11 raises a hardware interrupt (hardIRQ) to hardIRQ 81 (see reference sign c in FIG. 16) and netif_rx 82 performs the processing described below, which causes kernel 71 to notice the packet. Incidentally, the notation of an ellipse surrounding hardIRQ 81, illustrated in FIG. 16, represents a handler rather than a function part.

netif_rx 82 has a function of performing actual processing. When hardIRQ 81 (handler) has started execution (see reference sign d in FIG. 16), netif_rx 82 stores, into poll_list 86, information on a net device (net_device), which is one item of information of the content of the hardware interrupt (hardIRQ) and which indicates which device the hardware interrupt from NIC 11 comes from, and registers a dequeuing operation (see reference sign g in FIG. 16). Here, the dequeuing operation means to refer the content of a packet pooled in a buffer and, processing to be performed on the packet, taking into account the processing to be performed next, remove the corresponding queue entry from the buffer. Specifically, netif_rx 82, in response to the packet having been loaded into ring buffer 72, registers a dequeuing operation in poll_list 86 using a driver of NIC 11 (see reference sign e in FIG. 16). As a result, information on the dequeuing operation due to the packet having been loaded into ring buffer 72 is registered into poll_list 86.

In this way, in the device driver illustrated in FIG. 16, upon reception of a packet, NIC 11 copies the arrived packet to ring buffer 72 by a DMA transfer. In addition, NIC 11 raises hardIRQ 81 (handler), and netif_rx 82 registers net_device in poll_list 86 and schedules a software interrupt (softIRQ).

With the above-described processing, the hardware interrupt processing in device driver illustrated in FIG. 16 ends.

netif_rx 82 passes up, to softIRQ 83 (handler) via a software interrupt (softIRQ) (see reference sign f in FIG. 16), a request for dequeuing data stored in ring buffer 72 using information (specifically, a pointer) enqueued in the queue stacked in poll_list 86, thereby to communicate the request to notify do_softirq 84, which is a software interrupt control function part (see reference sign g in FIG. 16).

do_softirq 84 is a software interrupt control function part that defines functions of the software interrupt (there are various types of packet processing; the interrupt processing is one of them; it defines the interrupt processing). Based on the definition, do_softirq 84 notifies net_rx_action 85, which performs actual software interrupt processing, of a request for processing the current (corresponding) software interrupt (see reference sign h in FIG. 16).

When the order of the softIRQ comes, net_rx_action 85 calls, according to net_device registered in poll_list 86 (see reference sign i in FIG. 16), a polling routine configured to dequeue a packet from ring buffer 72, to dequeue the packet (see reference sign j in FIG. 16). At this time, net_rx_action 85 continues the dequeuing until poll_list 86 becomes empty.

Thereafter, net_rx_action 85 notifies netif_receive_skb 87 (see reference sign k in FIG. 16).

netif_receive_skb 87 creates a sk_buff structure, analyzes the content of the packet, and assigns processing to the protocol processor 74 arranged in the subsequent stage (see FIG. 15) in a manner depending on the type. That is, netif_receive_skb 87 analyzes the content of the packet and, when processing is to be performed according to the content of the packet, assigns (see reference sign 1 in FIG. 16) the processing to ip_rcv 88 of the protocol layer, and, for example, in the case of L2, assigns processing to arp_rcv 89 (see reference sign m in FIG. 16).

FIG. 17 illustrates an example of a transfer of video image data (30 FPS). The workload illustrated in FIG. 17 is to intermittently perform data transfer every 30 ms at a transfer rate of 350 Mbps.

FIG. 18 is a graph illustrating the CPU usage rate that is used by a busy-poll thread of KBP described in Non-Patent Literature 3.

As illustrated in FIG. 18, in the case of KBP, the kernel thread occupies a CPU core to perform busy polling. Even in the intermittent packet reception illustrated in FIG. 17, the CPU is used all the time in the case of KBP, regardless of whether a packet has arrived. This leads into a problem of an increase in the power consumption.

Next, a DPDK system is described.

### [DPDK System Configuration]

FIG. 19 is a diagram illustrating the configuration of a DPDK system that controls HW 110 including an accelerator 120.

The DPDK system includes HW 110, an OS 140, a DPDK 150, which is high-speed data transfer middleware deployed in a user space 160, and data processing APL 1.

Data processing APL 1 is packet processing to be performed prior to execution of an APL.

HW 110 performs data transmission/reception communication with data processing APL 1. In the following description, as shown in FIG. 19, the data flow in which data processing APL 1 receives a packet from HW 110 is referred to as “Rx-side reception”, and the data flow in which data processing APL 1 transmits a packet to HW 110 is referred to as “Tx-side transmission”.

HW 110 includes an accelerator 120 and NICs 130 (physical NICs) for connecting to communication networks.

Accelerator 120 is computing unit hardware that performs a specific operation at high speed based on an input from the CPU. Specifically, accelerator 120 is a graphics processing unit (GPU) or a programmable logic device (PLD) such as a field programmable gate array (FPGA). In FIG. 19, accelerator 120 includes a plurality of cores (core processors) 121, Rx queues 122 and Tx queues 123 that hold data in first-in-first-out list structures.

Part of the processing by data processing APL 1 is offloaded to accelerator 120, to achieve performance and power efficiency that cannot be achieved only by software (CPU processing).

There will be cases where accelerator 120 described above is applied in a large-scale server cluster such as a data center that implements network functions virtualization (NFV) or a software defined network (SDN).

NIC 130 is NIC hardware that forms a NW interface. NIC 130 includes an Rx queue 131 and a Tx queue 132 that hold data in first-in first-out list structures. NIC 130 is connected to a counterpart device 170 via, for example, a communication network and performs packet transmission/reception.

Note that NIC 130 may be a SmartNIC, which is an NIC equipped with an accelerator, for example. A SmartNIC is a NIC capable of offloading burdensome processing, such as IP packet processing that causes a decrease in processing capacity, to reduce the load of the CPU.

DPDK 150 is a framework for performing NIC control in user space 160, and specifically, is formed with high-speed data transfer middleware. DPDK 150 includes poll mode drivers (PMDs) 151 (drivers capable of selecting data arrival either in a polling mode or in an interrupt mode), which are each a polling-based reception mechanism. In each PMD 151, a dedicated thread continuously checks arrivals of data and performs reception processing.

DPDK 150 implements a packet processing function in user space 160 in which the APL operates, and, from user space 160, performs dequeuing immediately when a packet arrives according to a polling model, to shorten the packet transfer delay. That is, as DPDK 150 performs dequeuing of packets with polling (busy-polling the queues by CPU), there is no wait, and the delay is short.

### CITATION LIST

### Patent Literature

Patent Literature 1: JP 2015-197874 A

Patent Literature 2: JP 2018-32156 A

### Non-Patent Literature

Non-Patent Literature 1: New API Intel, [online], [retrieved on Nov. 5, 2021], the Internet <http://lwn.net/2002/0321/a/napi-howto.php3>

Non-Patent Literature 2: “Resource Setting (NIC)-DPDK Primer, Vol. 6 (in Japanese) (Resource Setting (NIC)—Introduction to DPDK, Part 6)”, NTT TechnoCross, [online], [retrieved on Nov. 5, 2021], the Internet <https://www.ntt-tx.co.jp/column/dpdk_blog/190610/>

Non-Patent Literature 3: Kei Fujimoto, Kenichi Matsui, Masayuki Akutsu, “KBP: Kernel Enhancements for Low-Latency Networking without Application Customization in Virtual Server”, IEEE CCNC 2021.

### SUMMARY OF THE INVENTION

### Technical Problem

However, the packet transfer based on the interrupt model and the packet transfer based on the polling model have the following problems.

In the interrupt model, the kernel that receives an event (hardware interrupt) from the HW performs packet transfer through software interrupt processing for performing packet processing. As the interrupt model transfers packets through an interrupt (software interrupt) processing, there is a problem in that when a contention with other interrupts occurs and/or when the interrupt destination CPU is in use by a process with a higher priority, a wait occurs, and thus the delay in packet transfer increases. In this case, if the interrupt processing is congested, the wait delay further increases.

A supplemental description will be given of the mechanism by which a delay occurs in the interrupt model.

In a general kernel, in packet transfer processing, packet transfer processing is performed in software interrupt processing after hardware interrupt processing.

When a software interrupt for packet transfer processing occurs, the software interrupt processing cannot be executed immediately under the conditions (1) to (3) described below. Thus, a wait in the order of milliseconds occurs due to the interrupt processing being mediated and scheduled by a scheduler such as ksoftirqd (a kernel thread for each CPU; executed when the load of the software interrupt becomes high).
(1) When there is a contention with other hardware interrupt processing
(2) When there is a contention with other software interrupt processing
(3) When the interrupt destination CPU is in use by another process or a kernel thread (migration thread, etc.), which has a higher priority.

Under the above conditions, the software interrupt processing cannot be executed immediately.

### <Network Delay Caused by Interrupt Processing Contention>

When a software interrupt for packet processing and a software interrupt for other processing (e.g. disk I/O or swapping) contend with each other, a scheduler (ksoftirqd) for software interrupts arbitrates software interrupt execution frequencies.

Occurrence of contention between software interrupts will be described. ksoftirqd schedules software interrupt processing. When processing is transferred to ksoftirqd, a software interrupt is executed at a frequency of config_hz (in the order of milliseconds). Due to this wait time, a packet transfer delay in the order of milliseconds occurs.

<problems Caused by New API (NAPI)>

A NW delay in the order of milliseconds also occurs in the same manner in the packet processing by New API (NAPI) due to a contention with an interrupt processing (softIRQ), as indicated in the dashed box n in FIG. 16.

### <Problem of Dpdk>

In DPDK, a kernel thread occupies the CPU core to perform polling (busy-polling the queues by the CPU). Therefore, even in the intermittent packet reception illustrated in FIGS. 17, 100% of the CPU is always used in the case of DPDK, regardless of whether a packet has arrived. Therefore, there is a problem in that the power consumption increases.

### <Problem of KBP>

The KBP also has a problem similar to that of the DPDK.

As described above, KBP is able to refrain softIRQ by constantly monitoring packet arrivals according to a polling model in the kernel, and thus is able to achieve low-latency packet processing.

However, as the kernel thread that constantly monitors packet arrivals occupies a CPU core and uses the CPU time all the time, there is a problem in that the power consumption increases. Referring now to FIGS. 17 and 18, a description will be given of a relationship between the workload and the CPU usage rate.

As illustrated in FIG. 18, in the case of KBP, the kernel thread occupies a CPU core to perform busy polling. Even in the intermittent packet reception illustrated in FIG. 17, the CPU is used all the time in the case of KBP, regardless of whether a packet has arrived. This leads into a problem of an increase in the power consumption.

As described, as DPDK embodies the polling model in a user space, no softIRQ contention occurs. As KBP embodies the polling model in the kernel, no softIRQ contention occurs. Thus, low-latency packet transfer is possible. However, both DPDK and KBP unnecessarily use CPU resources to constantly monitor packet arrivals, regardless of whether a packet has arrived. Therefore, there is a problem in that the power consumption increases.

The present invention has been made in view of such a background, and the present invention aims to lower the CPU usage rate to save power while maintaining low latency.

### Means for Solving the Problem

In order to solve the above problem, provided is an on-server data transmission device that performs sleep control on a polling thread of a data transfer part that performs packet transfer according to a polling model, the on-server data transmission device including: a traffic characteristic information collecting part configured to collect traffic characteristic information regarding the packet transfer; a polling determination part configured to, based on the traffic characteristic information received from the traffic characteristic information collecting part, generate polling schedule information for waking up the polling thread at a timing at which a packet arrival probability is equal to or greater than a predetermined threshold and causing the polling thread to sleep at other timings; and a polling instruction part configured to receive time synchronization information and the polling schedule information from the polling determination part, and based on the time synchronization information and the polling schedule information, deliver a polling schedule indicating a time and a time period in which polling is required to the polling thread to cause the polling thread to perform polling only for the time period indicated by the polling schedule.

### Advantageous Effects of the Invention

According to the present invention, it is possible to aim for saving power by lowering the CPU usage rate, while maintaining low latency.

### BRIEF DESCRIPTION OF THE DRAWINGS

FIG. 1 is a schematic configuration diagram of an on-server data transmission system according to an embodiment of the present invention.

FIG. 2 is an explanatory diagram for explaining: examples of channels, characteristics of data arrival, and sleep control schemes by a polling determination part, which are according to examples of data arrival patterns of the on-server data transmission system according to the embodiment of the present invention.

FIG. 3 is a diagram illustrating an example of information on channel allocation to time-frequency ranges, obtained from a traffic characteristic information collecting part of the on-server data transmission system according to the embodiment of the present invention.

FIG. 4 is an explanatory diagram for explaining an operation of the on-server data transmission system according to the embodiment of the present invention.

FIG. 5 is an explanatory diagram for explaining acquisition of a traffic characteristic of packet arrival statistics in cooperation with high-speed data transfer middleware of the on-server data transmission system according to the embodiment of the present invention.

FIG. 6 is a flowchart illustrating traffic characteristic information collection processing 1 of the traffic characteristic information collecting part of the on-server data transmission system according to the embodiment of the present invention.

FIG. 7 is a flowchart illustrating traffic characteristic information collection processing 2 of the traffic characteristic information collecting part of the on-server data transmission system according to the embodiment of the present invention.

FIG. 8 is a flowchart illustrating sleep control schedule determination processing in the polling determination part of the on-server data transmission system according to the embodiment of the present invention.

FIG. 9 is an explanatory diagram for explaining examples of data characteristic, what can be inferred from the characteristic, and sleep control schemes by the polling determination part, which are according to examples of statistical information of the on-server data transmission system according to the embodiment of the present invention.

FIG. 10 is a flowchart illustrating polling schedule information delivery processing of the polling determination part of the on-server data transmission system according to the embodiment of the present invention.

FIG. 11 is a subroutine illustrating a logic of determining whether to permit polling in the polling determination part of the on-server data transmission system according to the embodiment of the present invention.

FIG. 12 is a flowchart illustrating an operation of a polling instruction part of the on-server data transmission system according to the embodiment of the present invention.

FIG. 13 is a flowchart illustrating an operation of the high-speed data transfer middleware of the on-server data transmission system according to the embodiment of the present invention.

FIG. 14 is a hardware configuration diagram illustrating an example of a computer for embodying the functions of the on-server data transmission device of the on-server data transmission system according to the embodiment of the present invention.

FIG. 15 is a schematic diagram of Rx-side packet processing by New API (NAPI) implemented in Linux kernel 2.5/2.6 and later versions.

FIG. 16 is an explanatory diagram for explaining an outline of Rx-side packet processing by New API (NAPI) at the part surrounded by the dashed line in FIG. 15.

FIG. 17 is a diagram illustrating an example of transfer of video image data (30 FPS).

FIG. 18 is a diagram illustrating the CPU usage rate that is used by a busy-poll thread in KBP described in Non-Patent Literature 3.

FIG. 19 is a diagram illustrating the configuration of a DPDK system that controls HW including an accelerator.

### DESCRIPTION OF EMBODIMENTS

Hereinafter, an on-server data transmission system and the like in a mode for carrying out the present invention (hereinafter, referred to as “the present embodiment”) will be described with reference to the drawings.

### Embodiment

### [Overall Configuration]

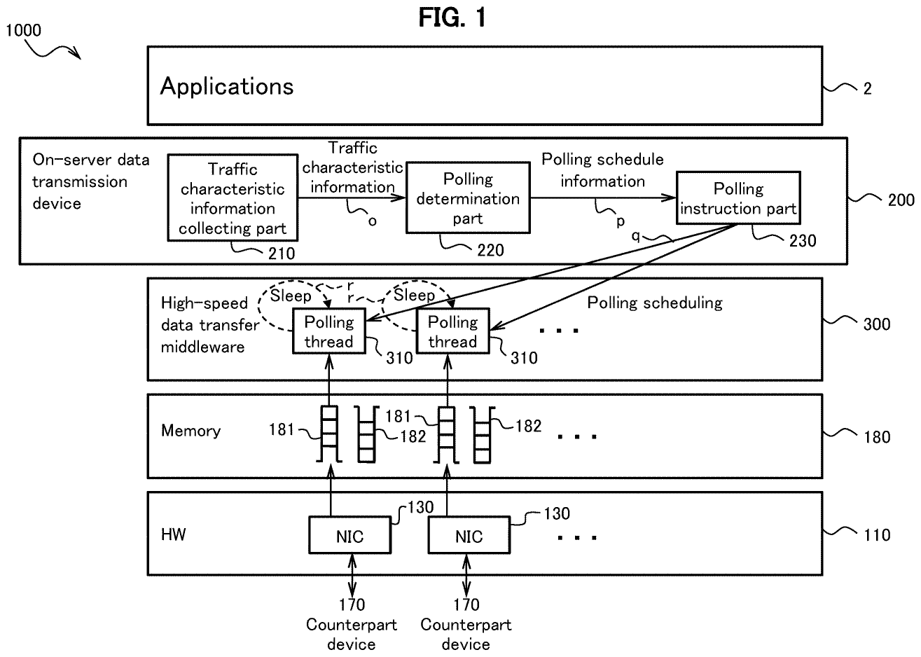

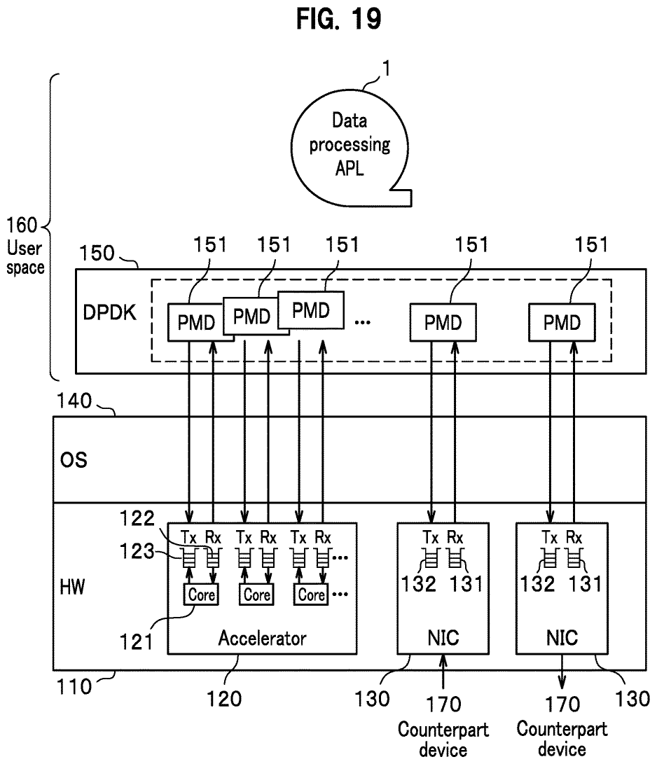

FIG. 1 is a schematic configuration diagram of an on-server data transmission system according to an embodiment of the present invention. The same components as those in FIG. 19 are denoted by the same reference signs thereas.

As illustrated in FIG. 1, an on-server data transmission system 1000 includes: HW 110; a memory 180; high-speed data transfer middleware 300 (a data transfer part) that executes packet transfer according to a polling model; an on-server data transmission device 200, which is sleep control middleware that perform sleep control on a polling thread(s) of high-speed data transfer middleware 300; and applications 2 (higher-level application), which are programs executed in a user space.

HW 110 includes NICs 130 (physical NICs) for connecting to counterpart devices 170. Each NIC 130 is NIC hardware that implements a NW interface and is connected to the counterpart device 170 via, for example, a communication network to perform packet transmission/reception.

HW 110 performs data transmission/reception communication with the applications 2. A data flow in which the applications 2 receive packets from the HW 110 will be hereinafter referred to as Rx-side reception, and a data flow in which the applications 2 transmit packets to the HW 110 will be hereinafter referred to as Tx-side transmission.

HW 110 may include an accelerator. The accelerator is computing unit hardware that performs a specific calculation at high speed based on an input from a CPU and is, for example, a graphics processing unit (GPU) or a programmable logic device (PLD) such as a field programmable gate array (FPGA).

Memory 180 is registers that store Rx queues 181 and Tx queues 182 that hold data in a first-in-first-out list structure.

### [On-Server Data Transmission Device 200]

On-server data transmission device 200 includes a traffic characteristic information collecting part 210, a polling determination part 220, and a polling instruction part 230.

### <Traffic Characteristic Information Collecting Part 210>

Traffic characteristic information collecting part 210 collects traffic characteristic information (channel allocation information (described later) and statistical information usable for a sleep control schedule, e.g. information on packets that have arrived in the past) and transmits the collected traffic characteristic information to polling determination part 220.

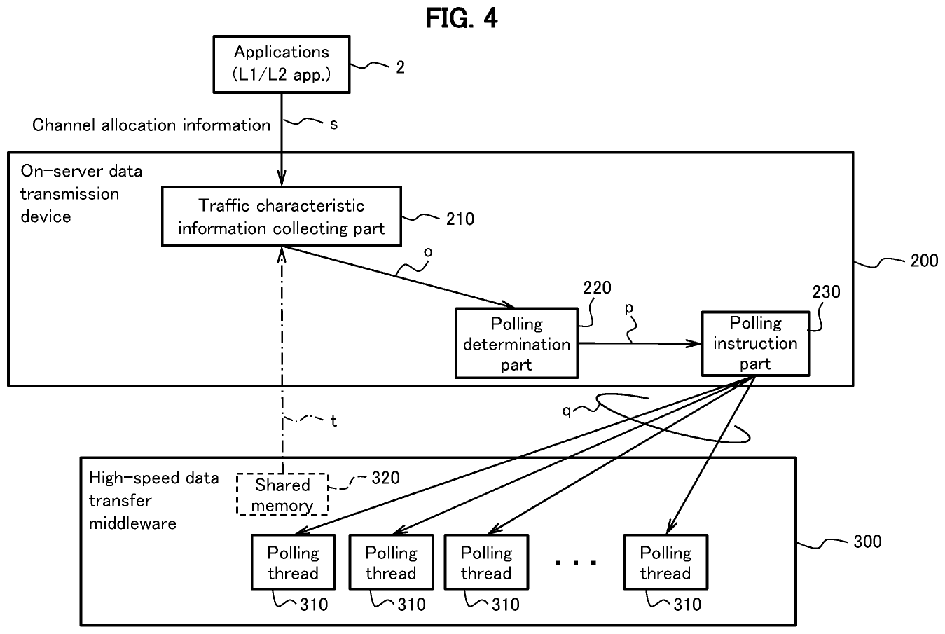

Specifically, traffic characteristic information collecting part 210 collects information on channel allocation to time-frequency ranges from applications 2 (see reference sign s in FIG. 4) and transmits the collected channel allocation information to polling determination part 220 as the traffic characteristic information (see reference sign o in FIG. 1).

In addition, traffic characteristic information collecting part 210 cooperates with high-speed data transfer middleware 300 to collect information usable for a sleep control schedule, such as a characteristic of a packet arrival frequency in time series, from high-speed data transfer middleware 300 and transmits the collected information to polling determination part 220 as the traffic characteristic information (see reference sign o in FIG. 1).

An example where traffic characteristic information collecting part 210 collects the channel allocation information (traffic characteristic information) from applications 2 is shown by reference sign s in FIG. 4 described later, and an example where traffic characteristic information collecting part 210 collects the statistical information (traffic characteristic information) usable for a sleep control schedule from high-speed data transfer middleware 300 is shown by reference sign t in FIG. 4 described later.

### <Polling Determination Part 220>

Polling determination part 220, based on the traffic characteristic information received from traffic characteristic information collecting part 210, generates polling schedule information, according to which a polling thread 310 of high-speed data transfer middleware 300 is caused to wake up at a timing at which a packet arrival probability is equal to or greater than a predetermined threshold and the polling thread 310 is caused to sleep at other timings, and transmits the polling schedule information to polling instruction part 230 together with time synchronization information (see reference sign p in FIG. 1).

The predetermined threshold of the packet arrival probability will be described.

The predetermined threshold is determined by an operator of the present system according to a use case and is stored in a storage part (not illustrated) as a table value, for example. Polling determination part 220 compares the packet arrival probability with the table value stored in the storage part and, when the packet arrival probability is equal to or greater than the predetermined threshold, generates polling schedule information that causes the polling thread 310 to wake up. Specifically:

(1) in a use case A, schedule information is generated based on a criterion that “the polling thread 310 should be caused to wake up at a timing at which a packet would arrive with a packet arrival probability of 99% or more”,

in a use case B, schedule information is generated based on a criterion that “the polling thread 310 should be caused to wake up at a timing at which a packet would arrive with a packet arrival probability of 80% or more”, and

in a use case C, schedule information is generated based on a criterion that “the polling thread 310 should be caused to wake up at a timing at which a packet would arrive with a packet arrival probability of 50% or more”.

(2) The operator can determine the threshold in advance within a probability range of 0 to 1(0% to 100%). There may be cases where the threshold of the probability may be 0 or 1, and there may be cases where the probability may not be applied practically (all probabilities are applied). For example, there may be an exclusion rule according to which the probability is not applied to specific UE or the like.

(3) The operator may dynamically change the threshold (in the above example, the threshold of 99%, the threshold of 80%, and the threshold of 50%).

### <Polling Instruction Part 230>

Polling instruction part 230 receives the time synchronization information and the polling schedule information from polling determination part 220, delivers a polling schedule indicating a time and a time period in which polling is required to the polling thread 310 based on the time synchronization information and the polling schedule information to trigger the polling thread 310, to cause the polling thread 310 to perform polling only for the time period indicated by the polling schedule.

Specifically, polling instruction part 230 issues an instruction on polling scheduling (see reference sign q in FIG. 1) to a polling thread 310 of high-speed data transfer middleware 300. As described later, the polling scheduling that polling instruction part 230 issues to the polling thread 310 is a trigger by which polling instruction part 230 causes the polling thread 310 to actually wake up.

### [High-Speed Data Transfer Middleware 300]

High-speed data transfer middleware 300 is a data transfer part that performs packet transfer according to a polling model. High-speed data transfer middleware 300 includes a plurality of polling threads 310, each of which is a program execution unit. A polling thread 310 wakes up from sleep in response to polling scheduling from polling instruction part 230 and performs packet transfer according to the polling model. The polling thread 310 receives the polling scheduling from polling instruction part 230, wakes up at a timing at which the packet arrival probability is equal to or greater than a predetermined value, and sleeps otherwise (see reference sign r in FIG. 1).

### [Categorization of Traffic According to Characteristics]

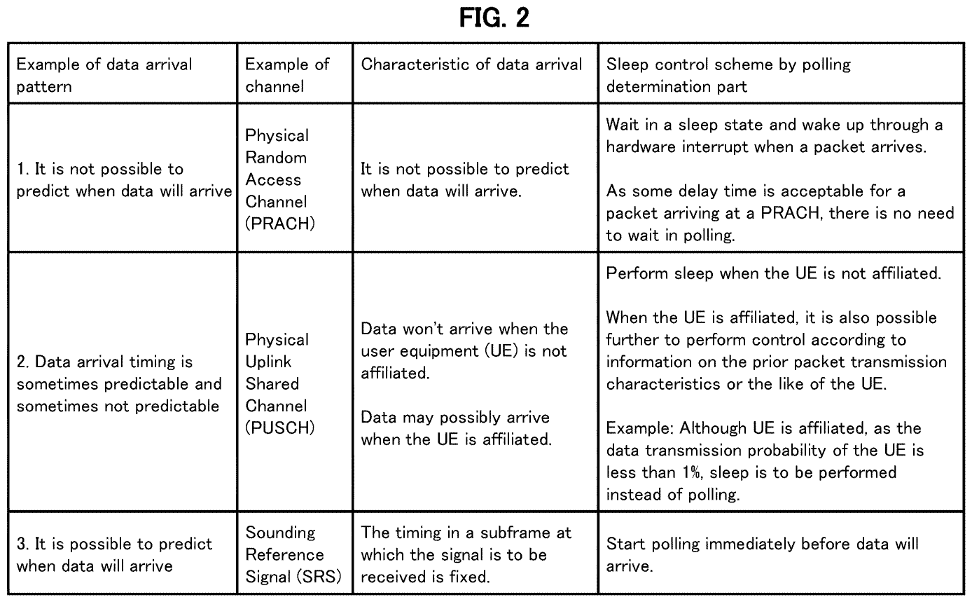

On-server data transmission device 200 causes the polling thread(s) in high-speed data transfer middleware 300 to wake up at a timing at which the packet arrival probability is equal to or greater than the predetermined value and otherwise causes the polling thread(s) to sleep. In order to implement such control, characteristics of data arrival patterns are categorized (see FIG. 2).

For example, in a radio access network (RAN) use case, the traffic may be categorized according to the characteristics, and the necessity of polling may be determined for each category.

A description will be given of examples of data arrival patterns and sleep control schemes according to them.

RAN is conceivable as a use case where the traffic characteristic information (see reference sign o in FIG. 1) which can be used for the sleep control schedule can be collected. The radio signal of RAN has a characteristic in the data arrival pattern for each channel. It is possible to define the sleep control schedule suitable for each characteristic.

FIG. 2 is an explanatory diagram for explaining: examples of channels, characteristics of data arrival, and sleep control schemes by polling determination part 220, which are according to examples of data arrival patterns.

The examples of data arrival patterns include: 1. a case where it is not possible to predict when data will arrive; 2. a case where the data arrival timing is sometimes predictable and sometimes not predictable; and 3. a case where the data arrival timing is predictable.

A channel example of case 1 where it is not possible to predict when data will arrive is a Physical Random Access Channel (PRACH) (first channel), and the characteristic of data arrival is “it is not possible to predict when data will arrive”. The sleep control scheme by polling determination part 220 is to wait in a sleep state and wake up through a hardware interrupt when a packet arrives. As some delay time is acceptable for a packet arriving at a PRACH, there is no need to wait in polling. When waiting in polling, there is no wake-up through a hardware interrupt, which leads to low latency. The case where it is not possible to predict when data will arrive generally pertains to a category in which some delay time is allowed. Therefore, there is no need to wait in polling, and waking up is made through a hardware interrupt.

A channel example of case 2 where there are both possibilities of the predictable case and the unpredictable case is a Physical Uplink Shared Channel (PUSCH) (second channel), and the characteristic of data arrival is “data won't arrive when the user equipment (UE) is not affiliated, and data may possibly arrive when the UE is affiliated”.

Affiliation of UE will be described. UE is, for example, a mobile terminal connected to a network of a base station. The network of the mobile terminal issues in advance a notification that communication is to be performed with resources divided according to a frequency range and a time range that can be used by the user's mobile terminal, and thus the mobile terminal knows that the mobile terminal can perform communication in the frequency range and the time range. Affiliation of UE means that the mobile terminal belongs to the frequency range and the time range specified by the base station (regardless of whether or not the mobile terminal is using them). Here, even when the mobile terminal is allocated to the frequency range and time range specified by the base station, it is not necessarily known whether the mobile terminal is affiliated with the frequency range and time range specified by the base station and is performing communication (in a case where the UE is affiliated, there are cases where communication is performed using resources thereof and cases where communication is not performed). A case where UE is not affiliated means a case where, although resources are allocated, no mobile terminal uses the resources (communication is not performed using the allocated resources).

The sleep control scheme by polling determination part 220 is to perform sleep when the UE is not affiliated. In a case where the UE is not affiliated, no data will arrive in the first place, and thus sleep is performed.

In a case where the UE is affiliated, it is also possible to perform control according to information on prior packet transmission characteristics or the like of the UE. For example, although UE is affiliated, as the data transmission probability of the UE is less than 1% (1% is an example and not limited to this), sleep is to be performed instead of polling.

A channel example of case 3 where it is possible to predict when data will arrive is a Sounding Reference Signal (SRS) (third channel), and the characteristic of data arrival is “the timing in a subframe at which the signal is to be received is fixed”. The sleep control scheme by polling determination part 220 is to start polling immediately before data arrives. When polling is started, there is no wake-up through a hardware interrupt, which leads to low latency. The channel example in a case where it is possible to predict when data will arrive (“SRS”) is irrelevant to the affiliation of the UE in the above-described case 2. SRS is a synchronization signal issued by the base station for time synchronization or a signal transmitted by the base station for obtaining information. The signal is transmitted by using a specific time-frequency range regardless of the usage state of the UE or the affiliation of the UE. As it is possible to predict when data will arrive, polling is started immediately before data arrives.

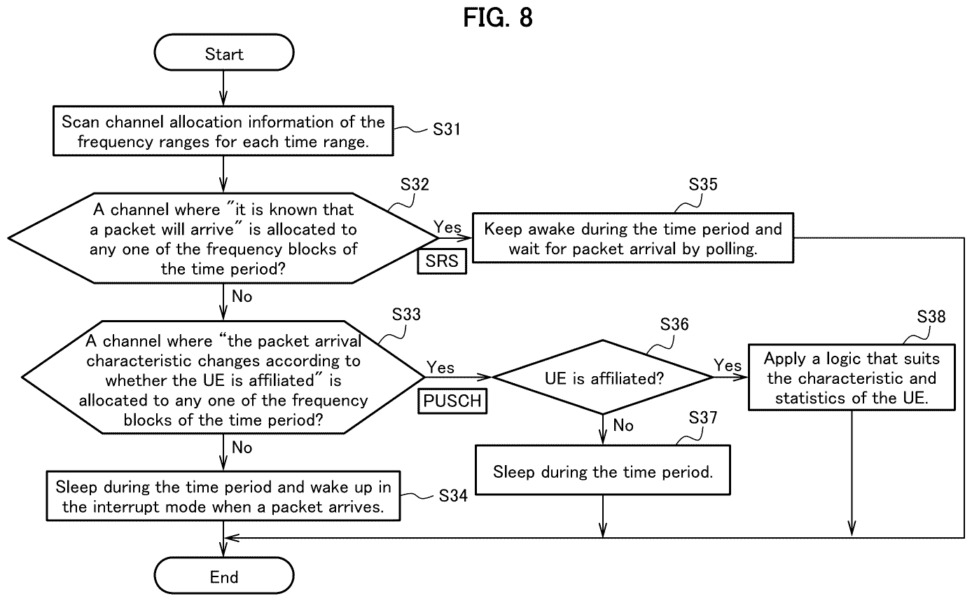

Note that determination on the sleep control schedule using the categorization of the data arrival pattern characteristics illustrated in FIG. 2 will be described later with reference to FIG. 8.

The traffic characteristic information by traffic characteristic information collecting part 210 will be described.

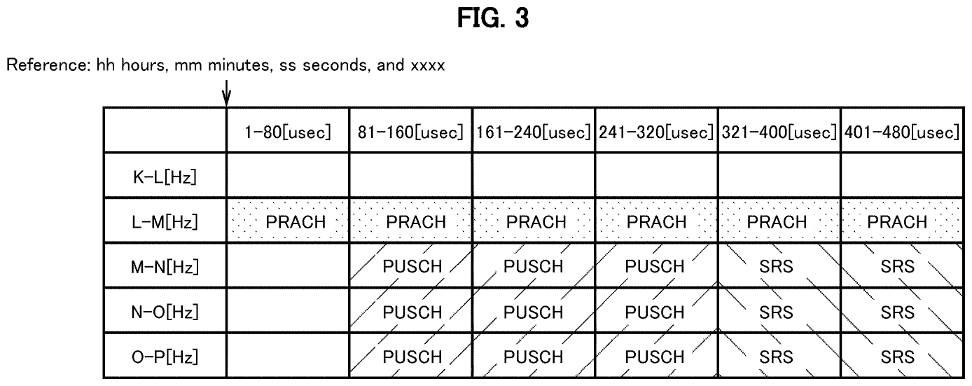

FIG. 3 is a diagram illustrating information on the channel allocation to the time-frequency ranges, obtained from traffic characteristic information collecting part 210, which is an example of the traffic characteristic information.

The channel allocation information illustrated in FIG. 3 is represented by channels allocated to the frequency ranges K-L [Hz], L-M [Hz], M-N [Hz], N-O [Hz], and O-P [Hz] for each of the time ranges 1-80 [usec], 81-160 [usec], 161-240 [usec], 241-320 [u sec], 321-400 [usec], and 401-480 [usec] from a reference: hh hours, mm minutes, ss seconds, and xxxx.

The channels allocated in combinations of 321-400 [usec], 401-480 [usec] and M-N [Hz], N-O [Hz], O-P [Hz] are SRSs having the highest priority such as synchronization signals. These SRSs are signals transmitted by using specific time-frequency ranges (an SRS will be referred to as a channel for the sake of convenience of description), and it is possible to predict when data will arrive.

The channels allocated in combinations of 81-160 [usec], 161-240 [usec], 241-320 [usec] and M-N [Hz], N-O [Hz], O-P [Hz] are PUSCHs. These PUSCH are channels where data arrival timing is sometimes predictable and sometimes unpredictable.

The channels allocated in combinations of L-M [Hz] and all the time periods of 1-80 [usec], 81-160 [usec], 161-240 [usec], 241-320 [usec], 321-400 [usec], and 401-480 [usec] are PRACHs. These PRACHs are channels where it is not possible to predict when data will arrive.

Blanks in FIG. 3 indicate a state in which no channel allocation information is available.

For example, in the frequency range L-M [Hz], a PRACH channel is allocated regardless of the time period (in all the time periods of 1-80 [usec], 81-160 [usec], 161-240 [usec], 241-320 [usec], 321-400 [usec], and 401-480 [usec]).

In the frequency ranges M-N [Hz], N-O [Hz], and O-P [Hz], there is no channel allocation information in 1-80 [usec] and PUSCH channels are allocated in 81-160 [usec], 161-240 [usec], and 241-320 [usec], whereas SRSs are allocated in 321-400 [usec] and 401-480 [usec].

Hereinafter, an operation of the on-server data transmission system configured as described above will be described.

### Overall Operation

FIG. 4 is an explanatory diagram for explaining an operation of the on-server data transmission system. The same components as those in FIG. 1 are denoted by the same reference signs as those in FIG. 1.

The applications 2 illustrated in FIG. 4 are, for example, L1/L2 applications (data processing applications for the physical layer/data link layer).

High-speed data transfer middleware 300 includes a shared memory 320 that holds information on a packet arrival frequency in time series. Shared memory 320 stores the number of times a packet has actually arrived at a resource block to which respective UE is allocated. Shared memory 320 conveys packet arrival statistics to traffic characteristic information collecting part 210 as statistical information usable for a sleep control schedule.

The traffic characteristic information collecting part 210 collects the traffic characteristic information as follows in, for example, an example applied to a RAN. That is, traffic characteristic information collecting part 210 periodically acquires information on the channel allocation to the time-frequency ranges from an L1/L2 application. Further, traffic characteristic information collecting part 210 performs time synchronization and passes the channel allocation information and time information together to polling determination part 220.

Traffic characteristic information collecting part 210 collects information on the packet arrival frequency via shared memory 320 and communicates the collected information to polling determination part 220 as the traffic characteristic information.

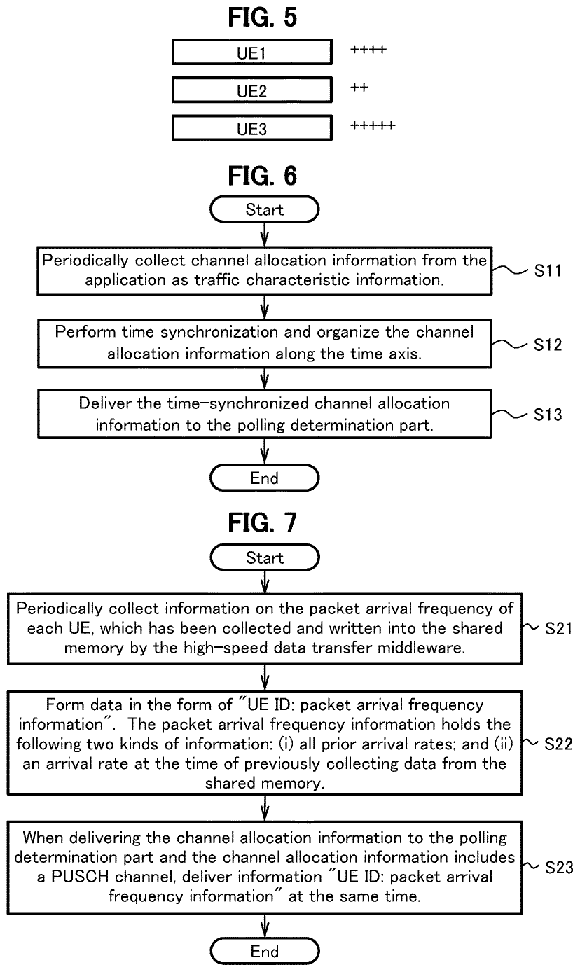

FIG. 5 is an explanatory diagram for explaining acquisition of the traffic characteristics of packet arrival statistics in cooperation with high-speed data transfer middleware 300. In FIG. 5, “+” indicates the number of times a packet has arrived at each UE. For example, in the case of UE 1, the number of times a packet has actually arrived at the resource block to which the UE 1 is allocated is four. Similarly, in the case of UE 2, the number of times a packet has arrived is two, and, in the case of UE 3, the number of times a packet has arrived is five.

High-speed data transfer middleware 300 collects the number of times a packet has actually arrived at the resource block to which respective UE is allocated and stores the number of times in the shared memory 320. High-speed data transfer middleware 300 communicates the information stored in shared memory 320 to traffic characteristic information collecting part 210 (see reference sign t in FIG. 4).

Based on the traffic characteristic information received from traffic characteristic information collecting part 210 (see FIG. 3), polling determination part 220 generates polling schedule information for waking up a polling thread 310 of high-speed data transfer middleware 300 at a timing at which the packet arrival probability is equal to or greater than a predetermined value and causing the polling thread 310 to sleep at other timings and communicates the polling schedule information to polling instruction part 230 (see reference sign p in FIG. 4).

Polling instruction part 230 receives the time synchronization information and the polling schedule information from polling determination part 220, and, based on the time synchronization information and the polling schedule information, delivers a polling schedule indicating a time and time period in which polling is required to the polling thread 310 of high-speed data transfer middleware 300 (see reference sign q in FIG. 4) to cause the polling thread 310 to perform polling only for the time period indicated by the polling schedule.

### [Operation of Traffic Characteristic Information Collecting Part 210]

### <Traffic Characteristic Information Collection Processing 1>

FIG. 6 is a flowchart illustrating traffic characteristic information collection processing 1 of traffic characteristic information collecting part 210. FIG. 6 shows a processing flow performed in a case where traffic characteristic information collecting part 210 acquires, from an L1/L2 application (higher-level application) (see reference sign s in FIG. 4), information on the channel allocation to time-frequency ranges.

In step S11, traffic characteristic information collecting part 210 (see FIG. 4) periodically (alternatively, at a timing at which the channel allocation pattern is changed) collects the channel allocation information from the L1/L2 application as the traffic characteristic information.

In step S12, traffic characteristic information collecting part 210 performs time synchronization and organizes the channel allocation information along the time axis. That is, as illustrated in FIG. 3, traffic characteristic information collecting part 210 arranges the channel allocation information along the time axis from the reference: hh (hours) mm (minutes) ss (seconds) XXXX.

In step S13, traffic characteristic information collecting part 210 delivers the time-synchronized channel allocation information to polling determination part 220 (see FIG. 4) and then terminates the processing of the present flow.

### <Traffic Characteristic Information Collection Processing 2>

FIG. 7 is a flowchart illustrating traffic characteristic information collection processing 2 of traffic characteristic information collecting part 210. FIG. 7 shows a processing flow performed in a case where traffic characteristic information collecting part 210 acquires packet arrival statistics from high-speed data transfer middleware 300 (see reference sign t in FIG. 4).

In step S21, traffic characteristic information collecting part 210 (see FIG. 4) periodically collects information on the packet arrival frequency of each UE, which has been collected and written into shared memory 320 (see FIG. 4) by high-speed data transfer middleware 300 (see FIG. 4).

In step S22, traffic characteristic information collecting part 210 (see FIG. 4) forms data in the form of “UE ID: packet arrival frequency information”. The packet arrival frequency information holds the following two kinds of information: (i) all prior arrival rates; and (ii) an arrival rate at the time of previously collecting data from shared memory 320 (see FIG. 4).

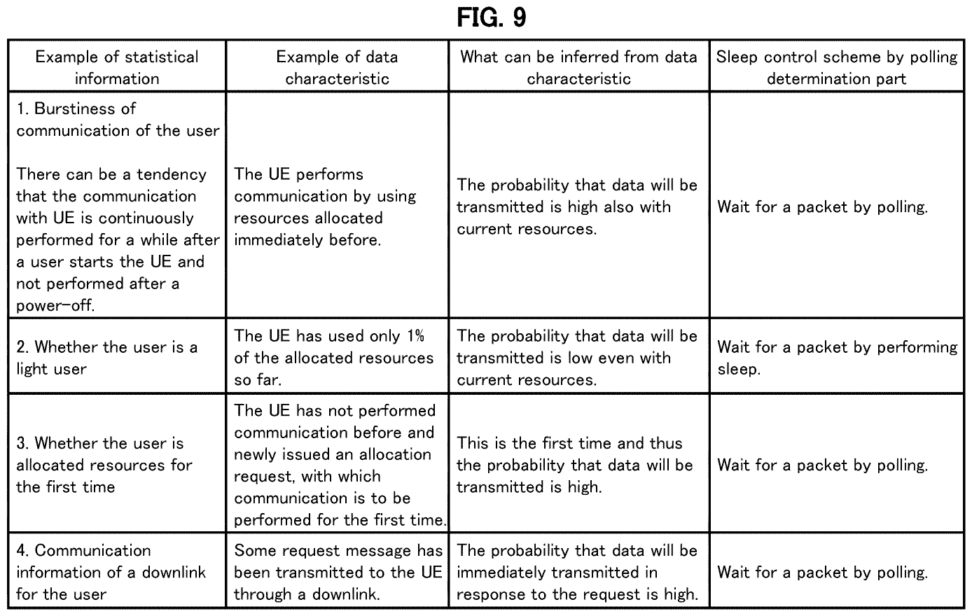

By using the packet arrival frequency information, traffic characteristic information collecting part 210 can determine whether “the UE has performed communication by using the resource allocated immediately before” and whether “the US is allocated resources for the first time” in FIG. 9 described later. Note that the UE is determined as the first UE when all the packet arrival rates and the previous packet arrival rate are acquired based on the ID assigned to the UE and when there is no previous packet arrival (for example, in a case where the ID of the UE is not recorded in the first place, the communication is determined as being performed for the first time).

In step S23, traffic characteristic information collecting part 210, when delivering the channel allocation information (see FIG. 3) to polling determination part 220 (see reference sign o in FIG. 4) and the channel allocation information includes a PUSCH channel, delivers information “UE ID: packet arrival frequency information” at the same time and terminates the processing of the present flow.

### <Correction of Data Arrival Timing Information>

Correction of data arrival timing information will be described.

There is a case where a regular difference between timing information which is passed by traffic characteristic information collecting part 210 (see FIGS. 1 and 4) to polling determination part 220 and the actual data arrival timing information occurs constantly or according to the data size or the like for the reason that time synchronization is not established with the counterpart device 170 illustrated in FIG. 1 or a certain data processing time is generated in the counterpart device 170. In this case, high-speed data transfer middleware 300 (see FIGS. 1 and 4) may transmit the actual packet arrival time to traffic characteristic information collecting part 210, and traffic characteristic information collecting part 210 may correct the difference.

Hereinabove, the operation of traffic characteristic information collecting part 210 has been described.

### [Operation of Polling Determination Part 220]

In the RAN use case, in a case where the information on the channel allocation to the time-frequency ranges illustrated in FIG. 3 is obtained from traffic characteristic information collecting part 210, polling determination part 220 determines the sleep control schedule as follows and generates the polling schedule information based on the determined sleep control schedule.

### <Sleep Control Schedule Determination Processing>

FIG. 8 is a flowchart illustrating sleep control schedule determination processing in polling determination part 220. This flow determines the sleep control schedule by using the categorization of the data arrival pattern characteristics illustrated in FIG. 2.

In step S31, polling determination part 220 scans the channel allocation information of the frequency ranges for each time range (in the present specification, scanning means checking the traffic characteristic information (see FIG. 3) sequentially in time from the reference to the end of time).

In step S32, polling determination part 220 determines whether a channel where “it is known that a packet will arrive” (“SRS” in the case of the traffic characteristic information in FIG. 3) is allocated to any one of the frequency blocks of the time period. For example, when scanning the traffic characteristic information illustrated in FIG. 3 from the reference to the end of time (1-80 [usec] to 401-480 [usec]), polling determination part 220 determines that an “SRS” is allocated in the cases where the frequency range is M-N [Hz], N-O [Hz], or O-P [Hz] and the time range is 321-400 [usec] or 401-480 [usec].

When a channel where “it is known that a packet will arrive” (“SRS”) is not allocated to any frequency block of the time period (S32: No), the processing proceeds to step S33, and, when such a channel is allocated (S32: Yes), the processing proceeds to step S35.

In step S33, polling determination part 220 determines whether a channel where “the packet arrival characteristic changes according to whether the UE is affiliated” (“PUSCH” in the case of the traffic characteristic information in FIG. 3) is allocated to any one of the frequency blocks of the time period. For example, when scanning the traffic characteristic information illustrated in FIG. 3 from the reference to the end of time (1-80 [usec] to 401-480 [usec]), polling determination part 220 determines that a “PUSCH” is allocated in the cases where the frequency range is M-N [Hz], N-O [Hz], or O-P [Hz] and the time range is 81-160 [usec], 161-240 [usec], or 241-320 [usec].

When a channel where “the packet arrival characteristic changes according to whether the UE is affiliated” (“PUSCH”) is not allocated to any frequency block in the time period (S33: No), the processing proceeds to step S34, and, when the channel is allocated (S33: Yes), the processing proceeds to step S36.

In step S34, polling determination part 220 determines a sleep control schedule such that the polling thread in high-speed data transfer middleware 300 is caused to sleep during the time period and is activated in an interrupt mode when a packet arrives, and terminates the processing of the present flow. That is, when a “PUSCH” is not allocated in step S33 described above, in step S34, polling determination part 220 waits in a sleep state and wakes up through a hardware interrupt when a packet arrives.

On the other hand, in step S32 described above, when an (“SRS”) has been allocated, in step S35, polling determination part 220 is awake during the time period and waits for packet arrival by polling, and then terminates the processing of the present flow. The polling determination part 220, by being awake during the time period and starting polling immediately before data arrives, avoids waking-up through a hardware interrupt to achieve low latency.

In step S33 described above, when a (“PUSCH”) has been allocated, in step S36, polling determination part 220 determines whether the UE is affiliated.

In step S36 described above, when the UE is not affiliated, in step S37, polling determination part 220 sleeps during the time period and terminates the processing of the present flow. In the case where the UE is not affiliated, data won't arrive in the first place even if a (“PUSCH”) is allocated. Thus, polling determination part 220 determines the sleep control schedule so as to sleep the polling thread in high-speed data transfer middleware 300 during the time period and terminates the processing of the present flow.

On the other hand, in step S36 described above, when the UE is affiliated, in step S38, polling determination part 220 applies a logic (the logic described later with reference to FIG. 9) that suits the characteristics and statistics of the UE, and terminates the processing of the present flow.

By the above processing, on-server data transmission device 200 can wake up the polling thread in high-speed data transfer middleware 300 at a timing at which the packet arrival probability is equal to or greater than a predetermined threshold and cause the polling thread to sleep at other timings (see “sleep control schedule determination in step S34”). When the packet arrival probability is significantly low, polling determination part 220 determines that it is appropriate to cause the polling thread to sleep.

However, in a case where the polling thread is caused to sleep because the packet arrival probability is significantly low, a packet may possibly arrive in the middle of sleeping. High-speed data transfer middleware 300 originally has a function of waking up in the interrupt mode when a packet arrives. In a case where a packet arrives in the middle of sleeping, high-speed data transfer middleware 300 wakes up in the interrupt mode by using this function (a hardware interrupt rises from the NIC and then high-speed data transfer middleware 300 wakes up in response to an instruction from the NIC). However, low latency cannot be achieved because high-speed data transfer middleware 300 wakes up in the interrupt mode. This is described in greater detail.

Waking up through a hardware interrupt has the following disadvantages. That is, a delay time increases in the case of waking up through a hardware interrupt, as compared with the case of polling. Thus, when high-speed data transfer middleware 300 is in a state of being awake and starts polling to acquire a packet, the delay time is shorter than that when high-speed data transfer middleware 300 wakes up from a hardware interrupt context. Therefore, the most ideal pattern is that high-speed data transfer middleware 300 wakes up in advance (in particular, immediately before a packet arrives) and starts polling, in which case the delay time is minimized. In the worst case, even when high-speed data transfer middleware 300 cannot wake up due to high-speed data transfer middleware 300 being in a sleep state, it is possible to wake up high-speed data transfer middleware 300 through a hardware interrupt, although the delay time slightly increases.

Incidentally, in a case where high-speed data transfer middleware 300 has woke up and is performing polling, high-speed data transfer middleware 300 prohibits raising a hardware interrupt. That is, even in a case where a hardware interrupt does not occur, it is possible to detect whether a packet has arrived by polling. Thus, there is no need to raise a hardware interrupt, and thus the hardware interrupt can be prohibited (polling is performed while raising the hardware interrupt is prohibited).

As described above, polling determination part 220 determines the sleep control schedule and generates the polling schedule information based on the determined sleep control schedule.

FIG. 9 is an explanatory diagram for explaining examples of data characteristic, what can be inferred from the characteristic, and sleep control schemes by the polling determination part 220, which are according to the examples of statistical information. FIG. 9 illustrates the logic according to the characteristic and statistics of the UE in step S38 of FIG. 8.

The examples of statistical information include: 1. burstiness of communication of the user; 2. whether the user is a light user; 3. whether the user is allocated resources for the first time; and 4. communication information of a downlink for the user. These will be described below in order.

1. A case where the example of statistical information is the burstiness of communication of the user

The example of data characteristic is “the UE is performing communication by using resources allocated immediately before”. What can be inferred from this data characteristic is “UE that has previously performed communication is highly likely to transmit data also with current resources”. The sleep control scheme by polling determination part 220 is to determine that the UE is highly likely to transmit data also with the current resources and wait for a packet by polling.

2. A case where the example of statistical information is whether the user is a light user (e.g., a user who, despite the UE is affiliated, has hardly performed communication by using allocated resources or a user who has only synchronized with a base station in the first time).

The example of data characteristic is “the UE has used only 1% of the allocated resources so far”. What can be inferred from the data characteristic is “the probability that data will be transmitted is low also with the current resources”. The sleep control scheme by polling determination part 220 is to determine that the UE is unlikely to transmit data with the resources and wait for a packet by performing sleep.

3. A case where the example of statistical information is whether the user is allocated resources for the first time

The example of data characteristic is “the UE has not performed communication before and newly issued an allocation request, with which communication is to be performed for the first time”. What can be inferred from the data characteristic is “this is the first time, and it is highly likely that data will be transmitted”. In a case of the first time, it is determined that, like the above-described case 1 of the UE that has previously performed communication, the UE is highly likely to transmit data, and the sleep control scheme by polling determination part 220 is to wait for a packet by polling.

4. A case where the example of statistical information is communication information of a downlink for the user (a link in a case where a message is transmitted from the base station to the UE)

The example of data characteristic is “some request message has been transmitted to the UE through a downlink”. What can be inferred from the data characteristic is “it is high likely that data will be immediately transmitted in response to the request”. In a case where the base station has transmitted a message to the UE, it is determined that the UE is highly likely to respond to the base station, and the sleep control scheme by polling determination part 220 is to wait for a packet by polling.

### <Polling Schedule Information Delivery Processing>

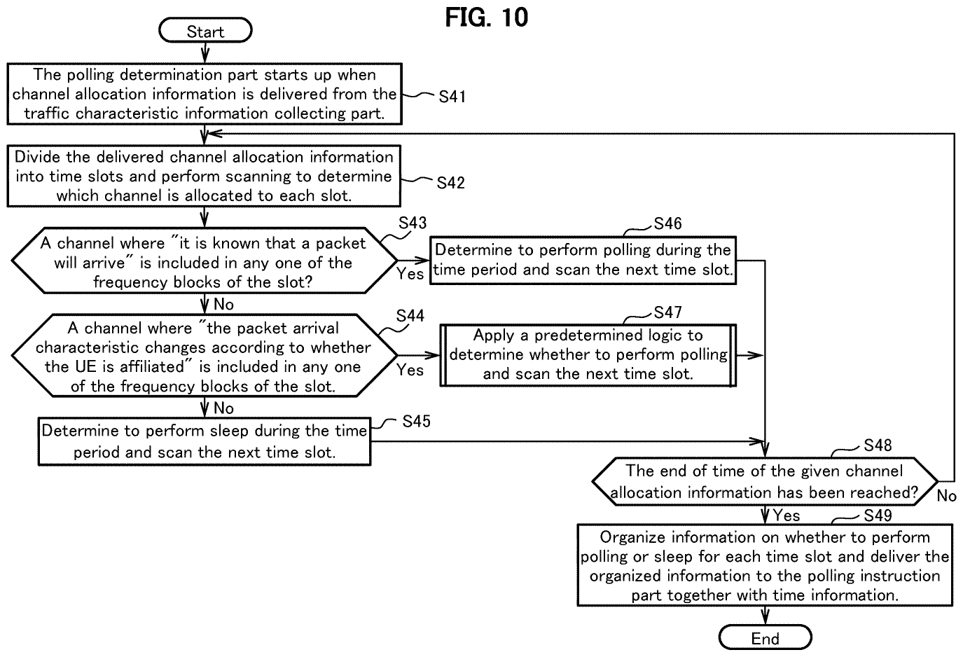

FIG. 10 is a flowchart illustrating polling schedule information delivery processing of polling determination part 220.

In step S41, polling determination part 220 starts the present program when the channel allocation information is delivered from the traffic characteristic information collecting part.

In step S42, polling determination part 220 divides the channel allocation information (see FIG. 3), which is collected from the applications 2 (L1/L2 application in FIG. 4) by traffic characteristic information collecting part 210 and delivered to polling determination part 220, into time slots (every 80 [usec] in the case of the example of FIG. 3) and performs scanning to determine which channel is allocated to each slot.

In step S43, polling determination part 220 determines whether a channel where “it is known that a packet will arrive” (“SRS” in the case of the traffic characteristic information in FIG. 3) is included in any one of the frequency blocks of the slot. Here, step S43 corresponds to step S32 in the flow of FIG. 8, and step S46 described later corresponds to step S35 in the flow of FIG. 8. In step S43, when an “SRS”, which has the highest priority, is allocated as the channel of the time-frequency range where it is known that a packet will arrive, the processing proceeds to step S46, instead of proceeding to step S44 and subsequent steps.

When a channel where “it is known that a packet will arrive” (“SRS”) is not included in any frequency block of the slot (S43: No), in step S44, polling determination part 220 determines whether a channel where “the packet arrival characteristic changes according to whether the UE is affiliated” (“PUSCH” in the case of the traffic characteristic information in FIG. 3) is included in any one of the frequency blocks of the slot. Here, step S44 corresponds to step S33 in the flow of FIG. 8, and step S47 described later corresponds to step S36 in the flow of FIG. 8.

That is, in step S44, determination is made as to whether “PUSCH”, which has the next highest priority after “SRS”, has been allocated, and, when a channel where “the packet arrival characteristic changes according to whether the UE is affiliated” (“PUSCH”) is not included in any frequency block of the slot (S44: No), in step S45, polling determination part 220 determines to sleep during the time period and scans the next time slot, and proceeds to step S48.

On the other hand, in step S43, when a channel where “it is known that a packet will arrive” (“SRS”) is included in any one of the frequency blocks of the slot (S43: Yes), in step S46, polling determination part 220 determines to perform polling during the time period and scans the next time slot, and proceeds to step S48.

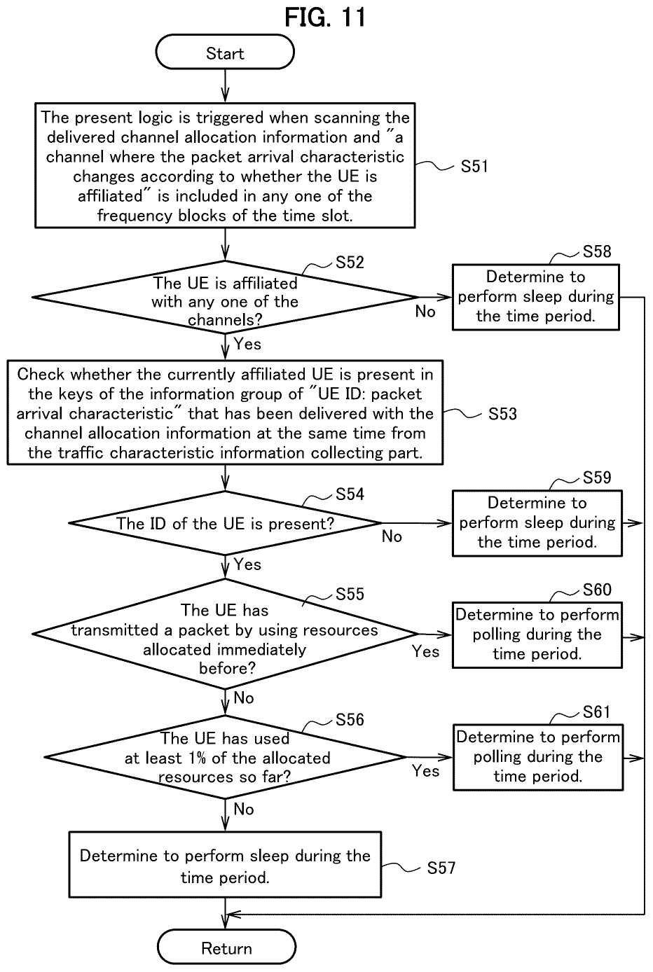

In step S44 described above, when a channel where “the packet arrival characteristic changes according to whether the UE is affiliated” (“PUSCH”) is included in any one of the frequency blocks of the slot (S44: Yes), in step S47, polling determination part 220 determines whether to perform polling by applying a predetermined logic (the logic shown as the subroutine illustrated in FIG. 11) and scans the next time slot, and proceeds to step S48.

In step S48, polling determination part 220 determines whether the end of time (end of time defined by traffic characteristic information collecting part 210 (a time section defining how far traffic characteristic information collecting part 210 collects next); for example, a time interval of 1 ms) of the given channel allocation information is reached.

When the end of time of the given channel allocation information has not been reached (S48: No), the processing returns to step S42 described above, and the above steps are repeated until the end of time of the channel allocation information is reached. When the end of time of the given channel allocation information has been reached (S48: Yes), the processing proceeds to step S49.

In step S49, polling determination part 220 organizes information on whether to perform polling or sleep for each time slot, delivers organized information to the polling instruction part together with time information (information for determining the reference of the time axis), and terminates the processing of the present flow. For example, polling determination part 220 organizes information on operations for every 80 [usec] as, for example, ten times of operations such that for the time slots (slot divided every 80 [usec] in the example illustrated in FIG. 8), polling is performed in a certain slot and sleep is performed in another slot, and passes the organized information (“information on whether polling is required”) to polling instruction part 230 together with the time information as the polling schedule information.

FIG. 11 is a subroutine showing a logic of polling determination part 220 determining whether to permit polling. FIG. 11 is called by the subroutine call in step S47 of FIG. 10 to be executed.

In step S51, when scanning the delivered channel allocation information, polling determination part 220 triggers (resets) the present logic in a case where the “channel where the packet arrival characteristic changes according to whether the UE is affiliated” is included in any one of the frequency blocks of the time slot.

In step S52, polling determination part 220 determines whether the UE is affiliated with any one of the channels.

In step S52 described above, when the UE is affiliated with any one of the channels (S52: Yes), in step S53, polling determination part 220 checks whether the currently affiliated UE is present in the keys of the information group of “UE ID: packet arrival characteristic” that has been delivered with the channel allocation information at the same time from traffic characteristic information collecting part 210.

In step S54, polling determination part 220 determines whether the ID of the UE is present.

In step S54 described above, when the ID of the UE is present (S54: Yes), in step S55, polling determination part 220 determines whether the UE has transmitted a packet by using the resources allocated immediately before.

In step S55 described above, when the UE has not transmitted a packet by using the resources allocated immediately before (S55: No), in step S56, polling determination part 220 determines whether the UE has used only 1% of the allocated resources so far, that is, whether the UE uses at least 1% of the allocated resources.

In step S56 described above, when the UE has not used 1% or more of the resources allocated so far (S56: No), in step S57, polling determination part 220 determines to perform sleep during the time period and returns to step S47 of FIG. 10.

On the other hand, in step S52, when the UE is not affiliated with any one of the channels (S52: No), in step S58, polling determination part 220 determines to perform sleep during the time period and returns to step S47 of FIG. 10. In the case of the present embodiment, as the present flow is called by the subroutine call in step S47 of FIG. 10 to be executed, the processing returns to step S47 of FIG. 10. However, the processing in FIG. 11 may be executed alone.

In step S54 described above, when the ID of the UE is not present (S54: No), in step S59, polling determination part 220 determines to perform sleep during the time period and returns to step S47 of FIG. 10.

In step S55 described above, when the UE has transmitted a packet by using the resources allocated immediately before (S55: Yes), in step S60, polling determination part 220 determines to perform polling during the time period and returns to step S47 of FIG. 10.

In step S56 described above, when the UE has used at least 1% of the resources allocated so far (S56: Yes), in step S61, polling determination part 220 determines to perform polling during the time period and returns to step S47 of FIG. 10.

Hereinabove, the operation of polling determination part 220 has been described.

### [Operation of Polling Instruction Part 230]

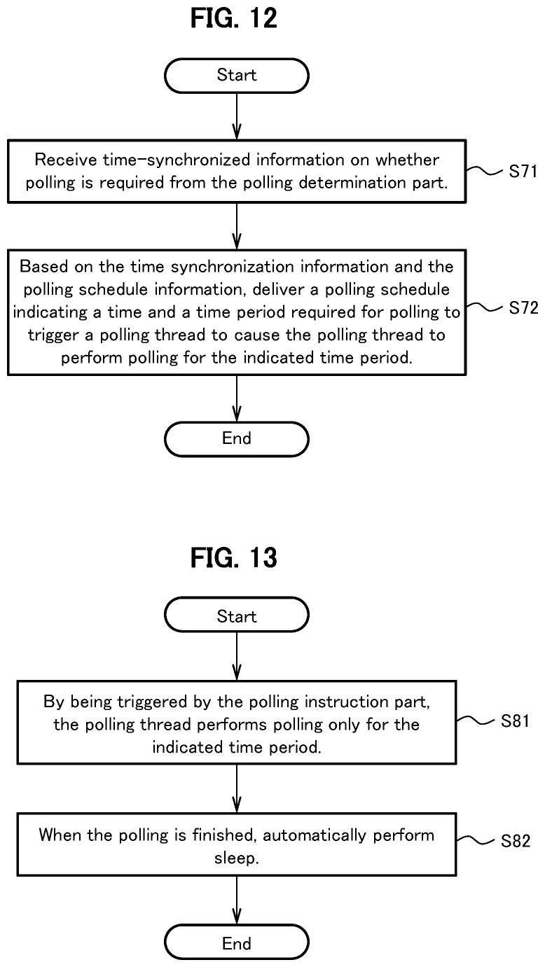

FIG. 12 is a flowchart illustrating an operation of polling instruction part 230.

In step S71, polling instruction part 230 (see FIGS. 1 and 4) receives (see step S49 of FIG. 10) the time-synchronized (for every 80 [usec] as shown in FIG. 3 for example) “information on whether polling is required” from polling determination part 220 (see FIGS. 1 and 4) (see step S49 of FIG. 10).

In step S72, polling instruction part 230 delivers a time and a time period in which polling is required to high-speed data transfer middleware 300, triggers the polling thread 310 (wakes up the polling thread 310) of high-speed data transfer middleware 300, and then terminates the processing of the present flow. The above-described triggering will be described. That is, polling instruction part 230 wakes up the polling thread 310 of high-speed data transfer middleware 300 immediately before the time period in which polling is to be performed. For example, polling instruction part 230 issues an instruction on starting of polling and a polling time period to the polling thread 310, for example, instructs the polling thread 310 to perform polling for the next 160 [usec] or to perform polling for the next 80 [usec]. As described, the term “to trigger” means that polling instruction part 230 causes the polling thread 310 to wake up actually (in FIG. 1, to trigger is described as “polling scheduling”).

### [Operation of High-Speed Data Transfer Middleware 300]

FIG. 13 is a flowchart illustrating an operation of high-speed data transfer middleware 300.

In step S81, in high-speed data transfer middleware 300 (see FIGS. 1 and 4), the polling thread 310 performs polling only for the indicated time period by being triggered by polling instruction part 230.

In step S82, when the polling is finished, high-speed data transfer middleware 300 automatically performs sleep and terminates the processing of the present flow.

### Hardware Configuration

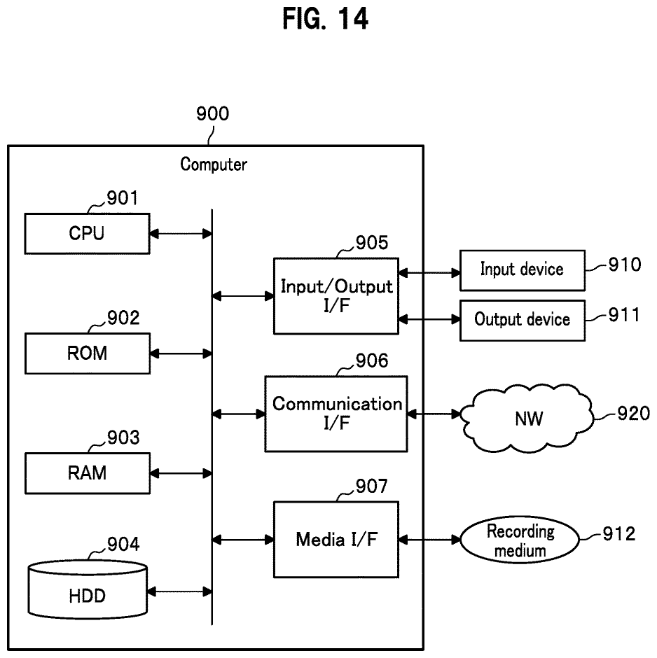

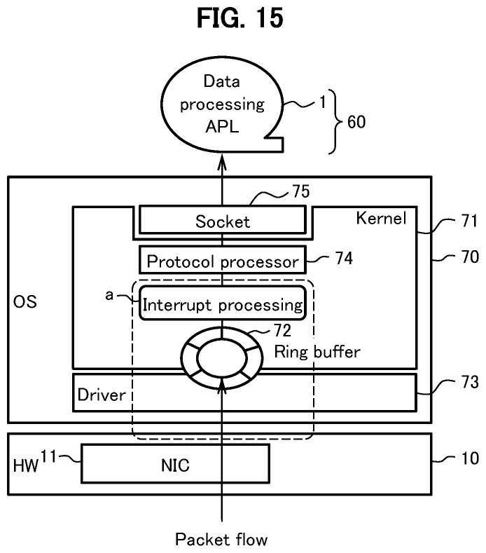

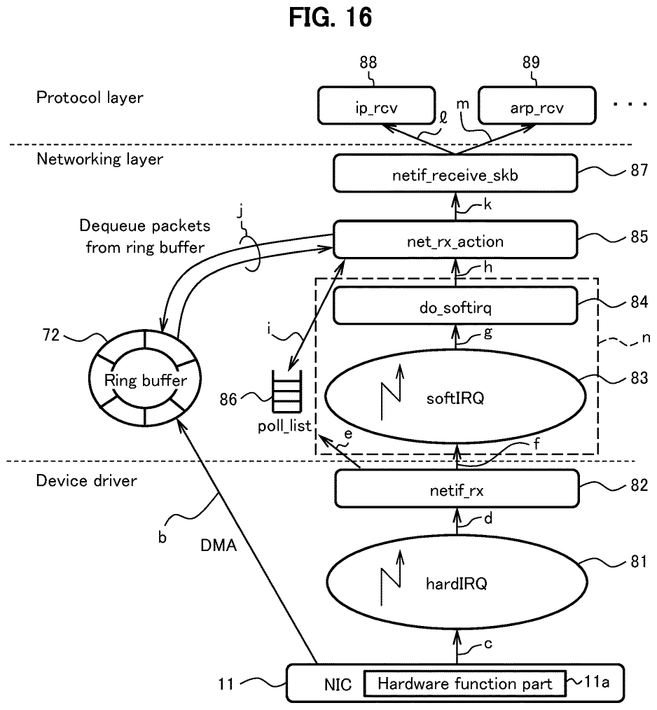

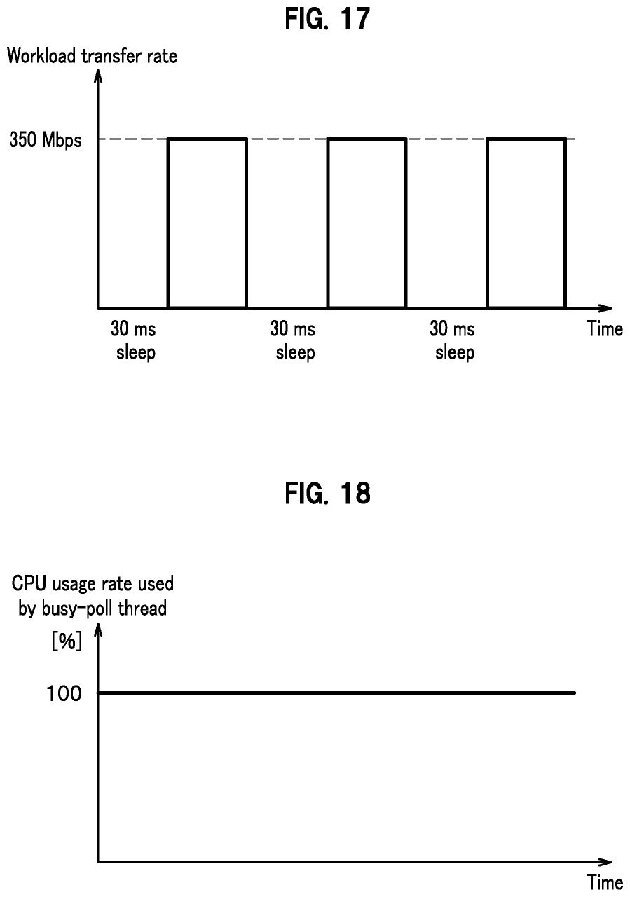

On-server data transmission device 200 according to the above-described embodiment is embodied by, for example, a computer 900 having a configuration such as illustrated in FIG. 14.

FIG. 14 is a hardware configuration diagram illustrating an example of computer 900 that embodies the functions of on-server data transmission device 200.

Computer 900 has a CPU 901, a ROM 902, a RAM 903, an HDD 904, a communication interface (I/F: Interface) 906, an input/output interface (I/F) 905, and a media interface (I/F) 907.

CPU 901 operates according to a program stored in ROM 902 or HDD 904, and controls components of on-server data transmission device 200 illustrated in FIGS. 1 and 4. ROM 902 stores a boot program to be executed by CPU 901 when computer 900 starts up, a program that relies on the hardware of computer 900, and the like.

CPU 901 controls an input device 910 such as a mouse and a keyboard and an output device 911 such as a display via an input/output I/F 905. CPU 901 acquires data from input device 910 via input/output I/F 905, and outputs generated data to output device 911. A graphics processing unit (GPU) or the like may be used together with CPU 901 as a processor.

HDD 904 stores programs to be executed by CPU 901, data to be used by the programs, and the like. Communication interface 906 receives data from another device via a communication network (e.g., network (NW) 920), sends the received data to CPU 901, and transmits data generated by CPU 901 to another device via the communication network.

Media I/F 907 reads a program or data stored in a recording medium 912 and provides the read program or data to CPU 901 via RAM 903. CPU 901 loads a program related to target processing from recording medium 912 onto RAM 903 via media I/F 907 and executes the loaded program. Recording medium 912 is an optical recording medium such as a digital versatile disc (DVD) or a phase change rewritable disk (PD), a magneto-optical recording medium such as a magneto-optical disk (MO), a magnetic recording medium, a conductor memory tape medium, a semiconductor memory, or the like.

For example, when computer 900 functions as on-server data transmission device 200 configured as one device according to the present embodiment, CPU 901 of computer 900 embodies the functions of on-server data transmission device 200 by executing the program loaded on RAM 903. Data in RAM 903 are stored in HDD 904. CPU 901 reads a program related to target processing from recording medium 912 and executes it. In addition, CPU 901 may read a program related to target processing from another device via a communication network (NW 920).

### Effects

As described above, an on-server data transmission device according to the present embodiment is on-server data transmission device 200 that performs sleep control on a polling thread (polling thread 310) of a data transfer part (high-speed data transfer middleware 300) that performs packet transfer according to a polling model. On-server data transmission device 200 includes: traffic characteristic information collecting part 210 configured to collect traffic characteristic information regarding the packet transfer; polling determination part 220 configured to, based on the traffic characteristic information received from traffic characteristic information collecting part 210, generate polling schedule information for waking up the polling thread at a timing at which a packet arrival probability is equal to or greater than a predetermined threshold and causing the polling thread to sleep at other timings; and polling instruction part 230 configured to receive time synchronization information and the polling schedule information from polling determination part 220, and based on the time synchronization information and the polling schedule information, deliver a polling schedule indicating a time and a time period in which polling is required to the polling thread to cause the polling thread to perform polling only for the time period indicated by the polling schedule.

With this configuration, polling determination part 220 determines, based on the traffic characteristic information received from traffic characteristic information collecting part 210, whether high-speed data transfer middleware 300 should perform reception processing in the polling mode or perform sleep and generates the polling schedule information. Based on the time synchronization information and the polling schedule information received from polling determination part 220, polling instruction part 230 delivers the polling schedule to the polling thread to cause the polling thread to perform polling only for the indicated time period. This makes it possible to wake up the polling thread in high-speed data transfer middleware 300 at a timing at which the packet arrival probability is equal to or greater than the predetermined threshold and cause the polling thread to sleep at other timings, thereby achieving low latency and power saving of data transfer.

The on-server data transmission device 200 can cause the delay of data transfer in the server by the polling model instead of the interrupt model, thereby achieving low latency. For example, in a use case where a sleep control schedule can be determined according to a traffic characteristic as in signal processing in RAN, on-server data transmission device 200 can perform a reception schedule according to the traffic characteristic by determining whether to wait for reception according to the polling model or sleep. With this, on-server data transmission device 200 can achieve power saving while maintaining low latency.

In on-server data transmission device 200, traffic characteristic information collecting part 210 collects channel allocation information in time-frequency ranges from a higher-level application (applications 2) and communicates the channel allocation information to polling determination part 220 as the traffic characteristic information.

As described, the L1/L2 application (higher-level application) has the channel allocation information in the time-frequency ranges for data transfer. Traffic characteristic information collecting part 210 can collect information used for the sleep control schedule from the higher-level application. Therefore, on-server data transmission device 200 can generally acquire the traffic characteristic information without adding a new component or the like or modifying the application.

In on-server data transmission device 200, the data transfer part (high-speed data transfer middleware 300) includes shared memory 320 that holds information on a packet arrival frequency in time series, and traffic characteristic information collecting part 210 collects the information on the packet arrival frequency via shared memory 320 and communicates the information on the packet arrival frequency to polling determination part 220 as the traffic characteristic information.

In this way, traffic characteristic information collecting part 210 can collect the information used for the sleep control schedule, such as the characteristic of the packet arrival frequency in time series, from the data transfer part (high-speed data transfer middleware 300). Therefore, on-server data transmission device 200 can acquire the information used for the sleep control schedule, such as the characteristic of the packet arrival frequency in time series, without modifying the application.

In on-server data transmission device 200, the traffic characteristic information includes channels whose packet arrival patterns (data arrival patterns) are allocated in time ranges and frequency ranges. The channels include: a first channel (“PRACH”) where packet arrival is unpredictable, a second channel (“PUSCH”) where packet arrival timing is sometimes predictable and sometimes unpredictable, and a third channel (“SRS”) where packet arrival is predictable. Polling determination part 220 is configured to: in a case of the first channel, generate the polling schedule information so as to cause the polling thread to wait in a sleep state and to wake up the polling thread through a hardware interrupt when a packet arrives: in a case of the second channel, generate the polling schedule information so as to cause the polling thread to sleep; and in a case of the third channel, generate the polling schedule information so as to cause the polling thread to start polling immediately before a packet arrives.

In this way, on-server data transmission device 200 can determine an appropriate sleep control schedule for each characteristic of the data arrival pattern for each channel as in the case of a radio signal of a RAN. Further, for a channel with which the UE is affiliated, such as the second channel (“PUSCH”), it is possible to generate a sleep control schedule to which statistics of the traffic experienced so far from the user are reflected.

### Application Example

On-server data transmission system 1000 (see FIG. 1) can be applied to traffic in which a characteristic in the time domain, such as the packet arrival frequency, is determined, and therefore can be applied not only to uplink traffic in the RAN but also to downlink traffic and the like.

Further, on-server data transmission system 1000 can be applied not only to a network counterpart but also to an accelerator counterpart.

Note that among the processing described regarding the above-described embodiments, all or some of the processing described as being automatically performed can also be manually performed, or all or some of the processing described as being manually performed can also be performed automatically using a known method. Also, the processing procedure, the control procedure, specific names, and information including various types of data and parameters, which have been described in the above-presented description and drawings can be changed as appropriate unless otherwise specified.

Also, each constituent element of the illustrated devices is a functional concept, and does not necessarily need to be physically configured as illustrated in the drawings. That is, the specific forms of the distribution and integration of the devices are not limited to those illustrated in the drawings, and all or some of the specific forms can be functionally or physically delivered or integrated in any unit according to various types of loads, usage conditions, and the like.

Also, the above configurations, functions, processing parts, processing means, and the like may be embodied by hardware by designing a part or all of them with, for example, an integrated circuit, or the like. Also, each of the above configurations, functions, and the like may be embodied by software for the processor to interpret and execute a program for realizing each function. Information such as programs, tables, and files that embody each function can be stored in a memory, a recording device such as a hard disk, or an SSD (Solid State Drive), or a recording medium such as an IC (Integrated Circuit) card, an SD (Secure Digital) card, or an optical disk.

### REFERENCE SIGNS LIST

2 Applications (higher-level applications)
110: HW
180 Memory
200 On-server data transmission device
210 Traffic characteristic information collecting part
220 Polling determination part
230 Polling instruction part
300 High-speed data transfer middleware (data transfer part)
310 Polling thread
320 Shared memory
1000 On-server data transmission system
PRACH (First channel)
PUSCH (Second channel)
SRS (Third channel)

1. An on-server data transmission device that performs sleep control on a polling thread of a data transfer part that performs packet transfer according to a polling model, the on-server data transmission device comprising:
a traffic characteristic information collecting part configured to collect traffic characteristic information regarding the packet transfer;
a polling determination part configured to, based on the traffic characteristic information received from the traffic characteristic information collecting part, generate polling schedule information for waking up the polling thread at a timing at which a packet arrival probability is equal to or greater than a predetermined threshold and causing the polling thread to sleep at other timings; and
a polling instruction part configured to receive time synchronization information and the polling schedule information from the polling determination part, and based on the time synchronization information and the polling schedule information, deliver a polling schedule indicating a time and a time period in which polling is required to the polling thread to cause the polling thread to perform polling only for the time period indicated by the polling schedule.

2. The on-server data transmission device according to claim 1,
wherein the traffic characteristic information collecting part collects channel allocation information in time-frequency ranges from a higher-level application and communicates the channel allocation information to the polling determination part as the traffic characteristic information.

3. The on-server data transmission device according to claim 1,
wherein the data transfer part includes a shared memory that holds information on a packet arrival frequency in time series, and
wherein the traffic characteristic information collecting part collects the information on the packet arrival frequency via the shared memory and communicates the information on the packet arrival frequency to the polling determination part as the traffic characteristic information.

4. The on-server data transmission device according to claim 1,
wherein the traffic characteristic information includes channels whose packet arrival patterns are allocated in time ranges and frequency ranges,
wherein the channels includes:
a first channel where packet arrival is unpredictable,
a second channel where packet arrival is sometimes predictable and sometimes unpredictable, and
a third channel where packet arrival is predictable, and
wherein the polling determination part is further configured to:
in a case of the first channel, generate the polling schedule information so as to cause the polling thread to wait in a sleep state and to wake up the polling thread through a hardware interrupt when a packet arrives,
in a case of the second channel, generate the polling schedule information so as to cause the polling thread to sleep, and
in a case of the third channel, generate the polling schedule information so as to cause the polling thread to start polling immediately before a packet arrives.

5. An on-server data transmission method of an on-server data transmission device that performs sleep control on a polling thread of a data transfer part that performs packet transfer according to a polling model, wherein the on-server data transmission method executes:
a traffic characteristic information collection step of collecting traffic characteristic information regarding the packet transfer;
a polling determination step of, based on the traffic characteristic information received in the traffic characteristic information collection step, generating polling schedule information for waking up the polling thread at a timing at which a packet arrival probability is equal to or greater than a predetermined threshold and causing the polling thread to sleep at other timings; and
a polling instruction step of receiving time synchronization information and the polling schedule information from the polling determination step, and based on the time synchronization information and the polling schedule information, delivering a polling schedule indicating a time and time period in which polling is required to the polling thread to cause the polling thread to perform polling only for the time period indicated by the polling schedule.

6. A non-transitory computer-readable medium storing a computer program for a computer serving as an on-server data transmission device that performs sleep control on a polling thread of a data transfer part that performs packet transfer according to a polling model, the computer program causing the computer to execute:
a traffic characteristic information collection procedure of collecting traffic characteristic information regarding the packet transfer,
a polling determination procedure of, based on the traffic characteristic information received from the traffic characteristic information collection procedure, generating polling schedule information for waking up the polling thread at a timing at which a packet arrival probability is equal to or greater than a predetermined threshold and causing the polling thread to sleep at other timings; and
a polling instruction procedure of receiving time synchronization information and the polling schedule information from the polling determination procedure, and based on the time synchronization information and the polling schedule information, delivering a polling schedule indicating a time and time period in which polling is required to the polling thread to cause the polling thread to perform polling only for the time period indicated by the polling schedule.
